(19) United States
(12) Patent Application Publication
(10) Pub. No.: US 2008/0147326 A1
(43) Pub. Date: Jun. 19, 2008

(54) METHOD AND SYSTEM OF PROCESSING INFORMATION DERIVED FROM GAS ISOTOPE MEASUREMENTS IN ASSOCIATION WITH GEOPHYSICAL AND OTHER LOGS FROM OIL AND GAS DRILLING OPERATIONS

(76) Inventor: Leroy Ellis, Richardson, TX (US)

Correspondence Address: Michael L. Diaz;Diaz and Associates, Suite 200, 555 Republic Drive, Plano, TX, 75074, US

(21) Appl. No.: 11/931,207

(22) Filed: Oct. 31, 2007

Related U.S. Application Data
(63) Continuation-in-part of application No. 11/671,043, filed on Feb. 5, 2007.
Application No. 11/671,043 is a continuation-in-part of application No. 10/952,136, filed on Sep. 28, 2004, now Pat. No. 7,174,254.
Application No. 10/952,136 is a continuation-in-part of application No. 10/845,743, filed on May 14, 2004, now Pat. No. 7,124,030.

(51) Int. Cl. G01V 9/00

(52) U.S. Cl. 702/9

(57) ABSTRACT

A system and method of interpreting well log isotopic information in a drilling operation of a target area. The method begins by inputting a template for indicating a trend from analyzed mud gas samplings into a computing system. Next, a plurality of mud gas samplings are profiled through a well bore at a plurality of incremental depths of the well bore. The plurality of gas samplings are analyzed to obtain a plurality of isotopic data points associated with hydrocarbon isotopic composition of the plurality of gas samplings. The plurality of isotopic data points includes data associated with a composition of ethane and methane or other gaseous components within each of the mud gas samplings. A trend associated with the template is determined by the computing system from the plurality of isotopic data points. The plurality of isotopic data points is analyzed to geochemically interpret the geological information.

### RELATED APPLICATIONS

This application is a continuation-in-part application of co-pending U.S. patent application Ser. No. 11/671,043 under the name of Leroy Ellis entitled “METHOD OF INTEGRATION AND DISPLAY OF INFORMATION DERIVED FORM A MUD GAS ISOTOPE LOGGING INTERPRETATIVE PROCESS IN ASSOCIATION WITH GEOPHYSICAL AND OTHER LOGS FROM OIL AND GAS DRILLING OPERATIONS” filed on Feb. 5, 2007 which is a continuation-in-part application of U.S. Pat. No. 7,174,254 under the name of Leroy Ellis entitled “MUD GAS ISOTOPE LOGGING INTERPRETATIVE PROCESS UTILIZING MIXING LINES IN OIL AND GAS DRILLING OPERATIONS” filed on Sep. 28, 2004 which is a continuation-in-part application of U.S. Pat. No. 7,124,030 entitled “MUD GAS ISOTOPE LOGGING INTERPRETIVE METHOD IN OIL AND GAS DRILLING OPERATIONS” filed on May 13, 2004 under the name of Leroy Ellis and is hereby incorporated by reference.

### BACKGROUND OF THE INVENTION

1. Field of the Invention

This invention relates to the interpretation of mudlog and geophysical log data with isotopic measurements associated with oil and gas drilling operations. Specifically, the present invention relates to the interpretation of data derived from mud gas isotopic measurements to assess hydrocarbon charge, source identification, maturity, reservoir compartmentalization, mis-pay, and hydrocarbon communication concomitant with identification of lithological seals, baffles and barriers with conventional oil and gas exploration and production geophysical logs.

2. Description of the Related Art

Analysis of gas samples obtained during a drilling operation may be employed to determine geochemical information associated with strikes of oil or gas deposits. The analysis may include the acquisition of compositional and isotopic data of sampled subsurface gases. This data is applied to traditional geochemical plots and templates. The interpretation of this data is used to provide geochemical information on the oil and gas provenance, how thermally mature the hydrocarbons are, whether subsurface post-generation effects were encountered during migration of the gaseous hydrocarbons from the source rock to a reservoir, and any problems or effects the hydrocarbons in the reservoir subsequently experienced.

Existing well sampling techniques use physical gas samples for compositional and isotopic analyses, obtained via wellheads, separators, down-hole logging tools (e.g., modular dynamic tester/repeat formation tester, etc.), canned cuttings, together with sampled gases entrained in the mud system during drilling.

As discussed in U.S. Pat. No. 7,124,030 and U.S. Pat. No. 7,174,254, there are several problems and issues not adequately addressed using standard mud gas chromatographic compositional analyses and interpretations. None of the existing techniques effectively detail or correlate geological information such as lithological hydrocarbon seals, baffles and barriers, good communication compartments, or gas diffusion and/or leakage into their interpretation. Compositional data can result in false positives and negatives where changes in operational conditions related to drilling variables such as increased rate of penetration or mud weight increases occur. U.S. Pat. Nos. 7,124,030 and 7,174,254 provide far more advanced methods which apply new interpretative techniques involving mud gas chromatographic compositional and isotopic analyses together with detailed drilling, geological and engineering information integration.

Within the improved interpretative techniques disclosed in U.S. Pat. Nos. 7,124,030 and 7,174,254 is the newly developed use of hydrocarbon mixing processes to determine or suggest good hydrocarbon communication compartments and zones. Subsurface gas mixing processes as defined by mixing lines are identified on plots where hydrocarbon gas compositional and isotopic data are plotted. The gas mixing lines may be employed and are defined by data points falling along an identified trend line, suggesting a depth section in the well that is in good gas communication, and therefore representative of a compartment. Breaks in any of the representative trends may identify approximate depth locations at which lithological seals, baffles or other barriers to hydrocarbon communication may in fact be present. The depth range of each trend may be considered to reflect or suggest an interval of good hydrocarbon communication. Furthermore, a number of seals baffles and barriers are suggested defining these intervals, supporting the interpretation that these intervals may be likely to show localized hydrocarbon communication zones concomitant with potentially serious compartmentalization issues.

In addition, U.S. patent application Ser. No. 11/671,043 incorporates the interpretative techniques disclosed in U.S. Pat. Nos. 7,124,030 and 7,174,254 for use with exploration mudlogs and other geophysical logs. Thus, U.S. patent application Ser. No. 11/671,043 provides a method and system for utilizing and integrating these logs in the interpretative process. However, the interpretative process disclosed in U.S. Pat. Nos. 7,124,030 and 7,174,254 utilizes plots. In addition, U.S. patent application Ser. No. 11/671,043 requires the use of logs to interpret the data. A system and method is needed which enables a user to interpret the acquired data based on mathematical integration of the data and not directly dependent on the use of plots or logs.

It would be a distinct advantage to incorporate the interpretative techniques disclosed in U.S. Pat. No. 7,124,030, U.S. Pat. No. 7,174,254, and U.S. patent application Ser. No. 11/671,043 with a system and method which interprets the data based on mathematical integration of the data and not directly dependent on the use of plots or logs. It is an object of the present invention to provide such a system and method.

### SUMMARY OF THE INVENTION

In one aspect, the present invention is a method of interpreting well log isotopic information in a drilling operation of a target area. The method begins by inputting a mathematical algorithm or other function (defined as a template) for indicating a trend from analyzed mudgas samplings into a computing system. Next, a plurality of mud gas samplings are profiled through a well bore at a plurality of incremental depths of the well bore. The plurality of gas samplings are analyzed to obtain a plurality of isotopic data points associated with isotopic composition of the plurality of gas samplings. The plurality of isotopic data points includes data associated with a composition of ethane and methane or other gaseous components within each of the mud gas samplings. A trend associated with the template is determined by the computing system from the plurality of isotopic measurements and data. The plurality of isotopic data points is analyzed to geologically interpret the geochemical information.

In another aspect, the present invention is a system for interpreting well log isotopic information in a drilling operation of a target area. The system includes a computing system for storing a template for defining and calculating a trend from analyzed mud gas samplings to a computing system. A user input (or other digital pipeline responsible for data transfer) is utilized for inputting a plurality of analyzed mud gas samplings into the computing system. The plurality of mud gas samplings are obtained from a target area. The computing system interprets the plurality of analyzed mud gas samplings to obtain compositional and isotopic data points from the plurality of gas samplings. The data points include information on composition of ethane and methane or other gaseous components within each of the mud gas samplings. The computing system analyzes, calculates, or determines trends identified with the template from the data points. An interpretation of the obtained mud gas samplings is then determined to provide an indication of hydrocarbon communication processes.

### BRIEF DESCRIPTION OF THE DRAWINGS

FIG. 1 is a block diagram illustrating principles of mud circulation during drilling operations and sampling of mud gases in the preferred embodiment of the present invention;

FIG. 2 is an exemplary table illustrating tabulated data of a typical mud gas composition and gas isotope sampling data for a drilling well;

FIG. 3 is a chart illustrating a percentage C1 versus isotopic data chart in the preferred embodiment of the present invention;

FIG. 4 is an example lithology illustrating the principles of lithology mixing of drilling cuttings in mud-stream at sand/shale boundaries;

FIGS. 5A-5C illustrate the principles of the mixing processes in mud gas samplings;

FIGS. 6A-6C illustrates the prediction of reservoir compartments and discontinuous reservoirs separated by seals, baffles or barriers via a thin shale lithology example;

FIG. 7 illustrates an example drilling well log formed by a percentage summed C1 to C6 hydrocarbons, gas units, and isotopic data at various depths;

FIG. 8 illustrates a first exemplary gas mixing plot showing C1/Cn versus δ¹³C₁;

FIG. 9 illustrates a second exemplary gas mixing plot showing C2/Cn versus δ¹³C₂;

FIG. 10 illustrates a third exemplary gas mixing plot showing C1/Cn versus isotopic data;

FIG. 11 illustrates an example well log formed by percentage C1-C6, gas units, and 13C methane;

FIG. 12 is a simplified block diagram of a computer system for interpreting sampled mud gas compositional and isotopic data in a drilling operation of a target area; and

FIG. 13 is a flow chart outlining the steps for interpreting engineering and geological interpretations from data determined from mud gas isotope logging according to the teachings of the present invention.

### DESCRIPTION OF THE INVENTION

The present invention is a system and method of utilizing acquired compositional and isotopic data for an interpretive method of mud gas isotope logging to determine hydrocarbon charge, source identification, maturity, reservoir hydrocarbon isotopic signature, good hydrocarbon communication, seals, baffles or other barriers to hydrocarbon communication in oil and gas drilling prospects.

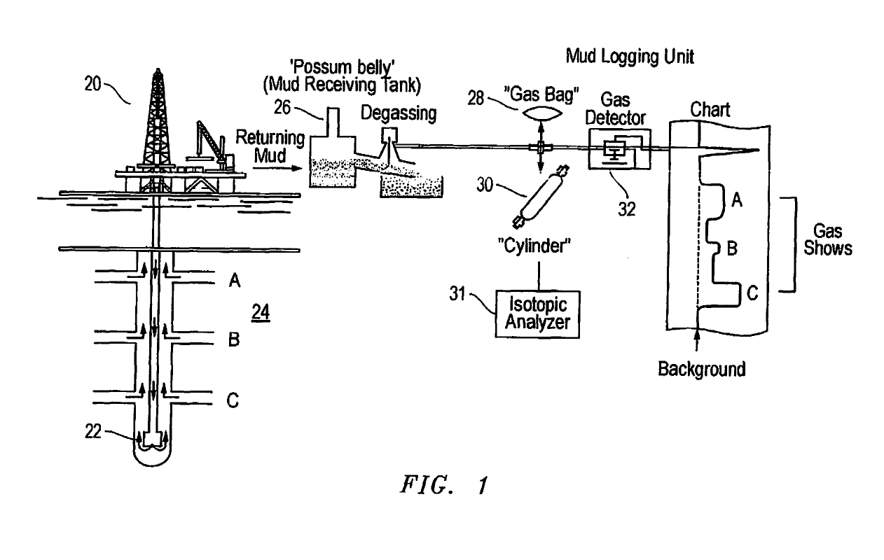

FIG. 1 is a block diagram illustrating principles of mud circulation during drilling operations and sampling of mud gases in the preferred embodiment of the present invention. A well 20 having a drill 22 drills down into the ground 24. Levels A, B, and C provide exemplary gas shows related to subsurface reservoirs. Mud is circulated around the drill 22 to provide lubrication for the drill and removing debris (cuttings) as it drills. The mud is circulated to the surface. The returning mud is collected on the surface within a mud receiving tank 26, also known as a possum belly. The gas is mechanically or otherwise degassed/exsolved form the mud and may be collected within a gas sampling device 28, a cylinder 30, or delivered to a mobile/onsite/in-situ isotopic analyzer 31. Typically, at a remote laboratory, mud logging unit, or an isotopic analyzer 31, a gas detector 32 (such as a gas chromatograph or mass spectrometer) is also utilized to measure compositional ratios of different hydrocarbon species.

In the preferred embodiment of the present invention, for a new drilling well, the samplings are taken at regular and/or continuous depths, throughout the entire well in order to establish a background trend, and recognize oil and gas charges in reservoirs and other shows. Gases entrained in the circulating mud streams typically see more restricted gas diffusion relative to other techniques such as canned-cuttings that may smear, distribute or be collected over a wide composite depth interval in the mud system due to inherent density and fractal characteristic differences. Therefore, the sample depth recorded for the gas samplings is considered to more closely approximate the actual depth, whereas canned-cuttings by nature may not accurately indicate the actual depth as rock density and fractal variables come into play during passage in the mud system. It should be understood by one skilled in the art that samplings may be taken in a wide variety of ways and is not limited to obtaining samplings at specific regular depths. Any isotopic measurement of samplings, involving either continuous (e.g., laser measurement techniques) or discrete samplings, may be utilized in the present invention.

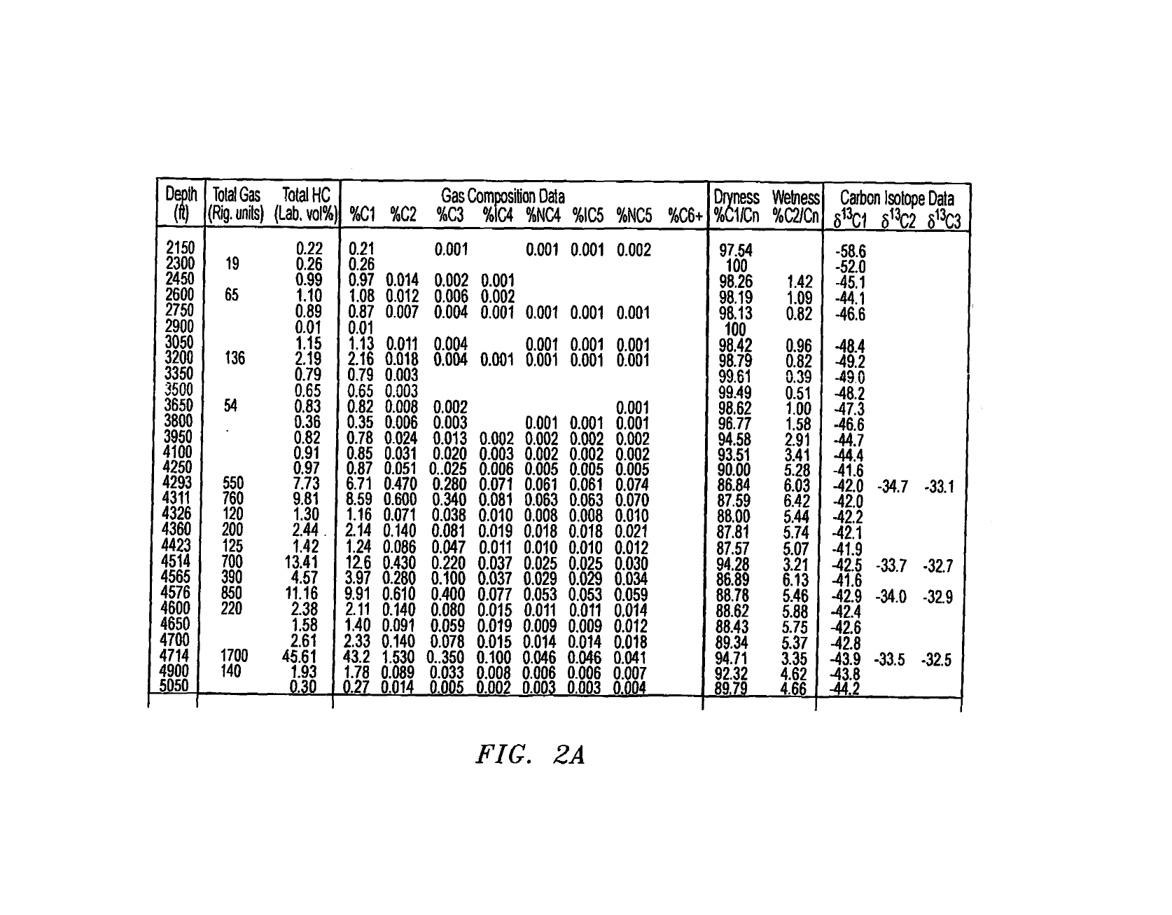

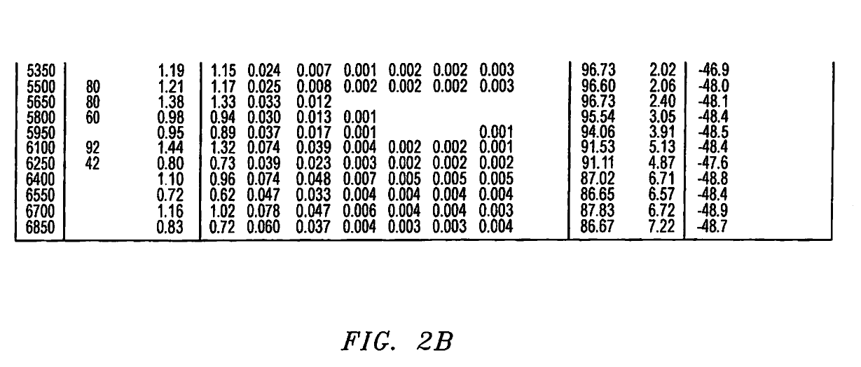

FIG. 2 is an exemplary table illustrating tabulated data of a typical mud gas composition and gas isotope sampling data for a drilling well. As discussed above, samplings are taken at regular intervals and/or continuously throughout the well. Alternatively, the samplings may be obtained in any fashion and may represent discrete or continuous measurements. The gas compositional data and isotopic data may be arranged in any fashion or combination of ratios. As illustrated in FIG. 2, matching rows are characterized by depth of the samplings. In the present invention, the data does not need to be presented in tabular form.

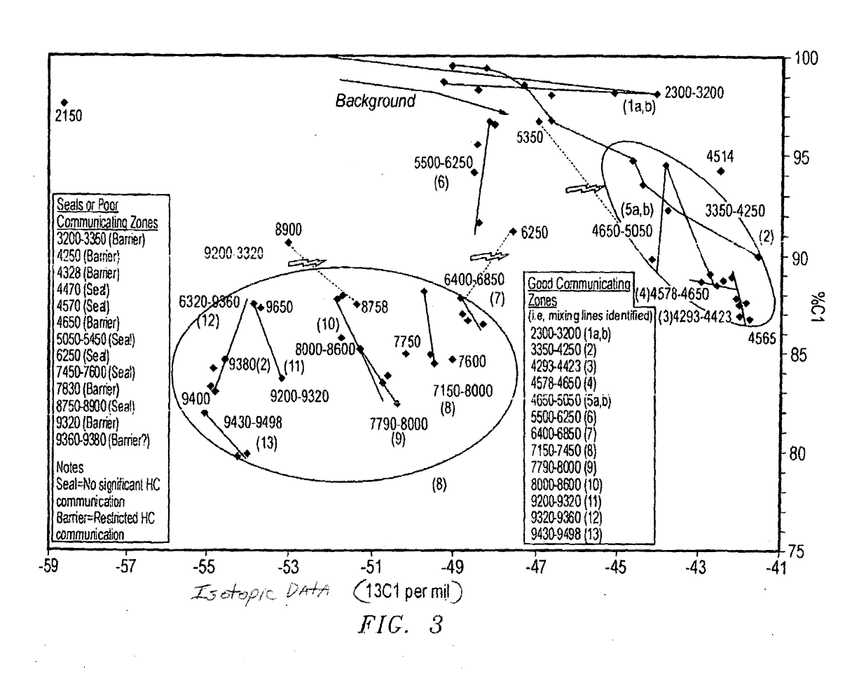

FIG. 3 is a chart illustrating a percentage C1 versus corresponding and related isotopic data (e.g., δ¹³C, ²H) chart in the preferred embodiment of the present invention. Percentage C1 may be illustrated on the one axis (e.g., Y-axis) and isotopic data displayed on the other axis (e.g., x-axis). Straight lines (which usually are defined by at least three sequential depth data points) or other identified trends within the data are then identified and referred to as “mixing lines.” These mixing lines equate to subsurface zones (compartments) in hydrocarbon gas communication. The points where the mixing lines start and end typically reveal “breaks” which may equate to lithological hydrocarbon communication seals, baffles or barriers. Baffles and barriers typically occur where a simple break in a mixing line occurs. Seals typically occur where the break is significant and the next depth data point deviates substantially. Either the next mixing line reverses direction or the next data point is far removed from the previous depth data point or mixing line. If the next (adjacent) mixing line reverses direction from one mixing line to another mixing line, this may represent one compartment where the point of reversal between the mixing lines may be representative of the actual reservoir hydrocarbon isotopic signature. If the next (adjacent) mixing line is substantially deviated, then a lithological seal, baffle or barrier may be indicated. FIG. 3 may include depth range labeling for any mixing line. Additionally, straight line-of-best-fit may also be drawn for data approximating a mixing line. Data groups that are tightly clustered are similarly interpreted to indicate good communication zones, analogous to mixing lines. From these data groups, a mathematical algorithm, formula, equation or function, known as a template, is applied to identify trends of the data.

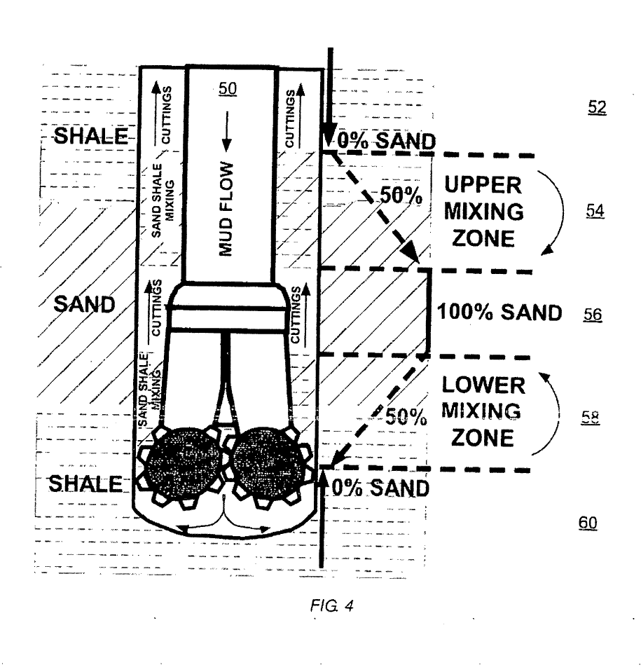

FIGS. 4-11, discussed below, provide an explanation and illustrate examples of the principles involved in interpreting the data. FIG. 4 is a lithology illustrating the mixing of cuttings in a mud stream at sand/shale boundaries. Mud flows from a drill bore 50 (associated with drill 22) and moves upward as illustrated. As shown in FIG. 4, an upper shale area 52 overlays an upper mixing zone 54, a sand region 56, a lower mixing zone 58, and a lower shale area 60. The shale cuttings may mix with the sand region from above due to the higher density of the shale cuttings. The shale cuttings from the lower shale area may also invade the sand region due to higher frictional and fractal characteristics.

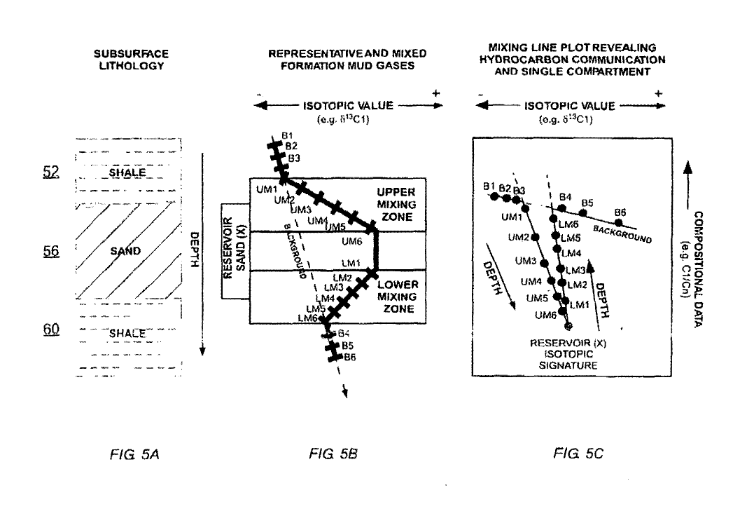

FIGS. 5A-5C illustrate the principles of related gas mixing processes entrained in drilling muds. FIG. 5A illustrates the lithology by showing the upper shale area 52, the sand region 56, and the lower shale area 60. The shales from the upper shale area 52 tend to cave. Specifically, shales may sink into the sand region due to lower buoyancy and higher density (more solids per volume) characteristics. Shale in the lower shale area 60 may upwell into the sand region due to higher frictional and/or fractal characteristics (more drag upwards; more particles/volume mud). FIG. 5B illustrates a chart showing depth versus isotopic data (e.g., δ¹³C₁). FIG. 5C is a gas mixing plot showing C1/Cn versus δ¹³₁ or other compositional and isotopic data. The intersection of the top and bottom of the mixing line determines reservoir composition of one continuous reservoir where the point of reversal between the mixing lines may be representative of the actual reservoir hydrocarbon isotopic signature. The mixing of lithologies results in the mixing of associated gases. Mixing plots allow differentiation between hanging and footwall mixing.

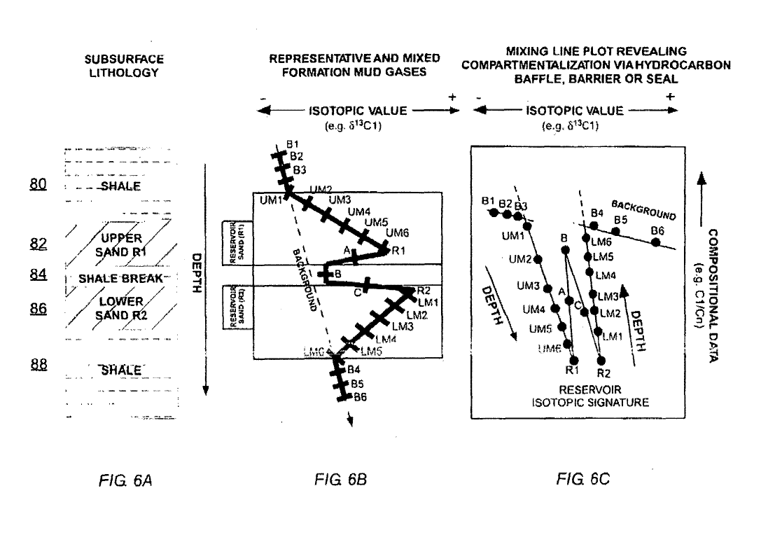

FIGS. 6A-6C illustrates the prediction of reservoir compartments and discontinuous reservoirs separated by a thin shale, other lithology or geological phenomena. FIG. 6A illustrates the lithology showing an upper shale region 80, a sand region 82, a shale break 84, a sand region 86, and a lower shale region 88. Within the sand region 82 is a reservoir R1. Within the sand region 86 is a second reservoir R2. In a similar manner as FIG. 5B, FIG. 6B illustrates the processes of gas mixing and expected isotopic mixing trends in a reservoir separated by a thin shale. FIG. 6C illustrates a gas mixing plot showing C1/Cn versus δ¹³C₁.

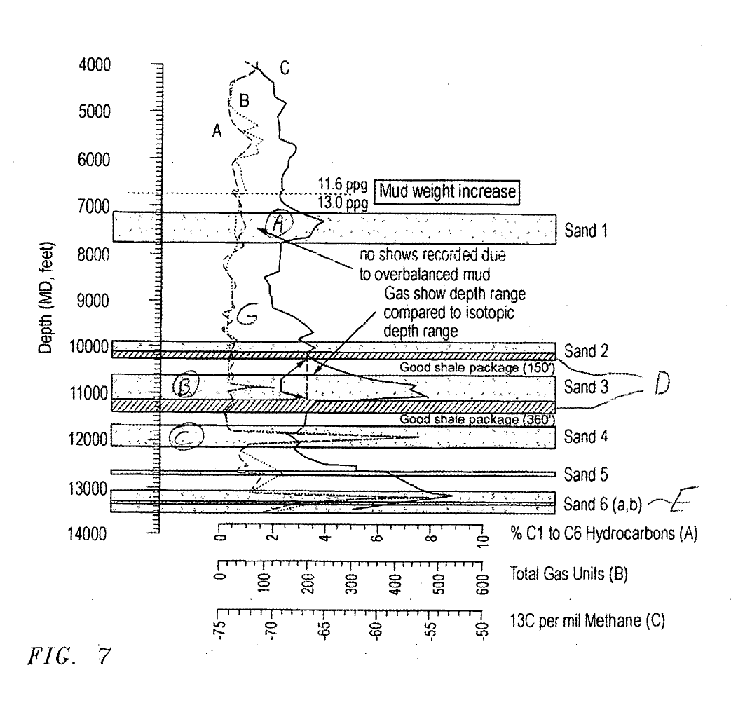

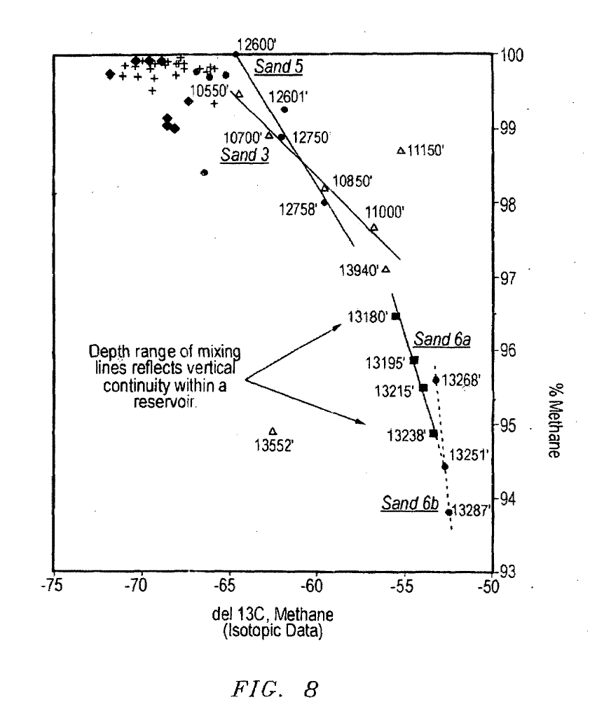

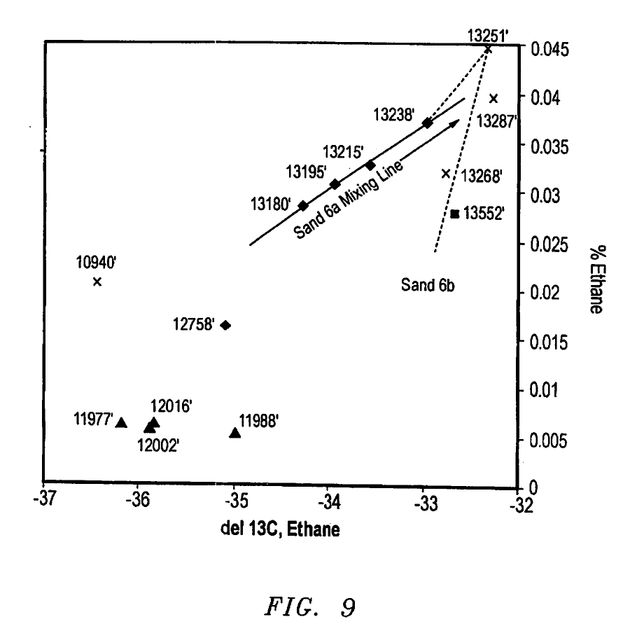

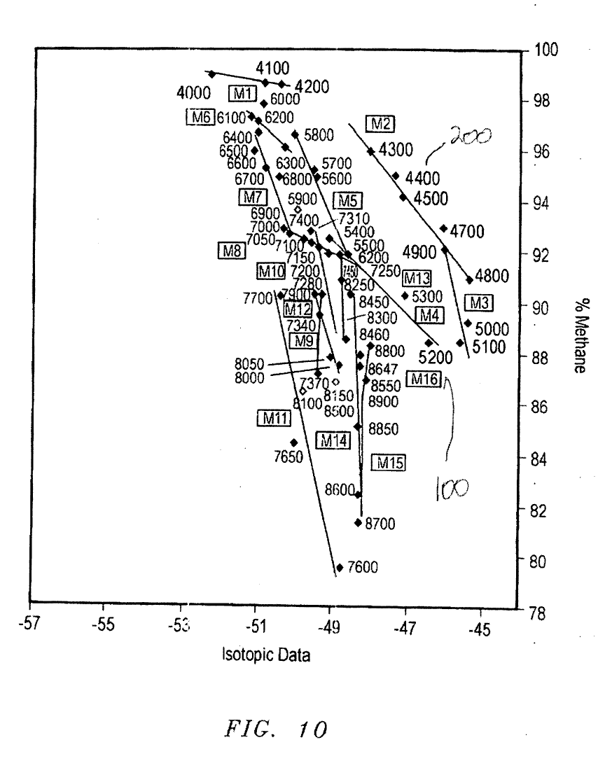

FIG. 7 illustrates an example drilling well log formed by percentage C1 to C6 hydrocarbons, gas units and isotopic data at various depths. FIG. 7 provides a real-world example of missed-pay (A), charge recognition (B), biodegradation (C), seal identification (D), compartmentalization (E), hydrocarbon diffusion or leakage (F) and background (G). An absence of gas shows also recognizes missed-pay potential due to operational drilling variables such as overbalanced mud weight. An absence of an isotopic show may be indicative of a non-economical background gas-charged sand or biodegraded gas/oil mixture. An isotopic peak profile may also recognize gas cap seal integrity in reservoirs. Gas shows correspond to isotopic shows in typical charged sands. Sand 6 illustrates thin shale in sand, which results in compartmentalization. FIGS. 8 and 9 show associated mixing lines.

FIG. 8 illustrates a gas mixing plot showing C1/Cn versus δ¹³C₁. Sands 3 and 5 (see FIG. 7) form closely approximating mixing lines, which indicate a possible relationship between these reservoirs. Sand 6a forms a good mixing line down to approximately 13251 feet, which while still within the reservoir suggests that this reservoir is compartmentalized. Separation of the mixing lines 6a and 6b illustrates identification of a seal, baffle or barrier between 13238 feet and 13251 feet. The depth range of mixing lines reflects vertical continuity within each reservoir. The present invention may be utilized for determining and comparing compartmentalization and hydrocarbon communication between wells across a field or other stratigraphic zone.

FIG. 9 illustrates a gas mixing plot showing C2/Cn versus δ¹³C₂. This plot, similar to FIG. 8 employs ethane (C2) compositional and associated isotopic data to provide an early assessment of reservoir continuity and compartmentalization. Sand 6a represents a mixing line, whereas sand 6b is, at best, a different mixing line. Sand 6a mixing line terminates at a point between 13238 feet and 13251 feet (similar to FIG. 8) suggesting that a seal, baffle or barrier to communication may be present. Sand 6a and 6b appear to be separate compartments with zero or limited gas communication. The identification of a seal, baffle or barrier between 13238 feet and 13251 feet using ethane data further supports and validates similar interpretations arrived at in FIG. 8 using methane compositional and isotopic data.

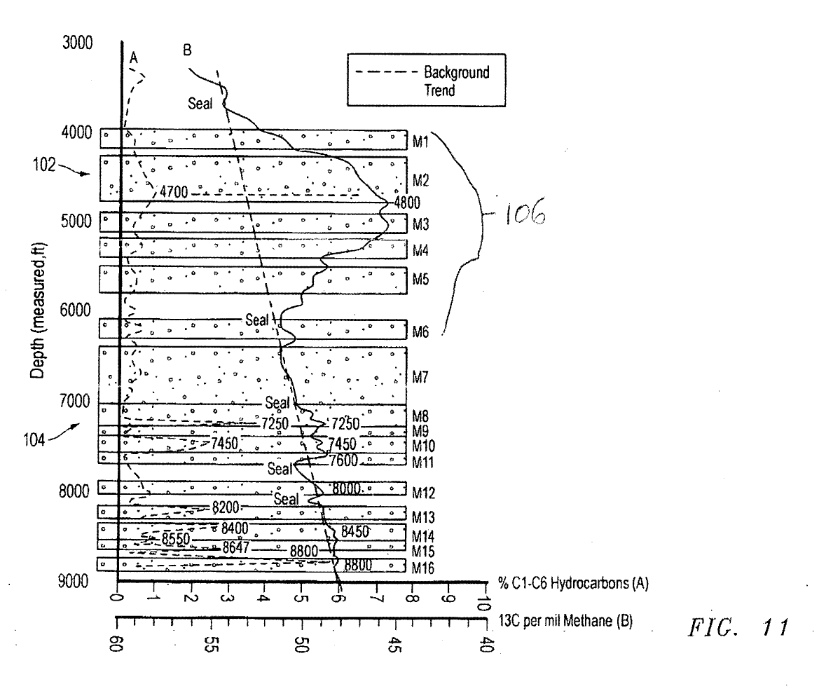

FIG. 10 illustrates another real-world example of a gas mixing plot showing C1/Cn versus isotopic data (e.g., δ¹³C₁) and shows an early assessment of reservoir continuity, compartmentalization and hydrocarbon communication. Mixing trends are easily recognized with the resulting depth range of lines reflecting separate compartments and continuity. The recognition of breaks (e.g. reference number 100) between related depth intervals (i.e., formation of separate mixing lines) suggests that a baffle or other lithological barrier to communication may exist. Mixing processes of sands and shales (e.g. reference number 200) in the circulating mud stream can also be observed.

FIG. 11 illustrates an example log displaying percentage C1-C6 and 13C methane isotopic data. There are sixteen distinct gas communication compartments interpreted and identified. Reference number 102 shows the mixing line depth ranges superimposed on the gas compositional and isotopic log depths. Reference number 104 shows where isotopic shows and the gas shows agree. Mixing lines located in the same region on a plot reflecting discrete compartments (e.g., M1-M6 at reference number 106) may also be consolidated into broader stratigraphic compartments encompassing a number of smaller discrete compartments that may be determined to be related via observation or integration with other well log data and information.

The interpretive methodology may be used for reservoir seal identification. Seal integrity measured as a function of its ability to restrict reservoir gas diffusion or other hydrocarbon leakage may be observed through mud gas isotope logging. Data from wells may indicate diffusion or leakage of reservoir gases into formations both above and below identified reservoirs. This data present and support potential identification of low- and high gas reservoir saturations. Low gas saturations are commonly ascribed to leaky seals. If there is a leaky seal, the gas in the overlying seal interval may develop an isotopic signal similar to that of the underlying reservoir gas, and in contrast to the background shale methane and ethane isotopic ratios. In contrast, an intact seal may have some mixing a short interval above the reservoir, but overall, the overlying lithology should have a lighter, more constant methane and ethane isotopic signal. Therefore, an intact seal as discussed above may indicate high gas saturation, combined with a distinctly different gas isotopic signature in the reservoir. Seals that are intact, and seals that leak, may be identifiable from a change in background isotopic signatures (See FIGS. 4, 5, and 7). This provides calibration between physical property measurements of the shales or other caprocks and their ability to seal. Seals, however, may only be identified/recognized using this technique over a depth interval in which appropriate detailed mud gas isotope logging data have been acquired. This hydrocarbon diffusion or leakage process is likely to occur over geologic time and terminates upon contact with an impermeable barrier such as a continuous/homogeneous dense and compacted lithology (e.g. shale, marl, chalk, or other geological phenomena with associated pore pressure changes) of low porosity/permeability. Seals such as these may be generally referred to as ‘trapping’ seals, or more specifically as, ‘regional’ or ‘localized’ seals depending on their stratigraphic extent between wells. These seals represent barriers to the potential migration of hydrocarbons within and between wells. Identification of seals is important in establishing potential migration pathways and reservoir compartmentalization in a field. Reservoir sands within identified particular regional seals are likely to contain gases of the same type and maturity.

Reservoir seals are not as well understood as either source or reservoir rocks, and evaluating and predicting reservoir seals remain problematic. Within this context, mud gas isotope logging is a promising technique for both complementing existing seal analysis methodology and empirically verifying the presence of any seal, regardless of origin.

Mud gas isotope logging is a noninvasive technique used to evaluate exploration and field production. Isotopic measurements made on mud gas samplings from either side of a potentially sealing interval can be used to determine the effectiveness of a seal as well as establish likely migration pathways and reservoir compartmentalization. For example, in a thermogenic gas reservoir associated with a leaky seal, gas in the overlying seal may develop an isotopic signature similar to that of the underlying reservoir gas. This leaky seal isotopic signature will be isotopically heavier and contrast with methane and ethane isotopic ratios in background shales. In contrast, an effective seal in this same thermogenic setting will have an isotopically lighter and more constant methane and ethane signal. By measuring changes in background isotopic signal of intact seals vs. seals that leak, calibration between physical property measurements of the seals and their ability to seal can be determined.

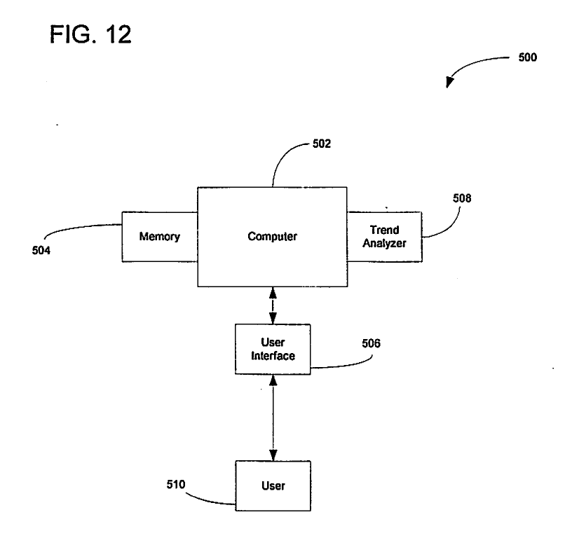

It should be understood that plotting data upon a plot as shown in the above referenced figures (i.e., FIGS. 2A, 2B, 3, 5B, 5C, 6B, 6C, and 7-11) is not necessary for implementing the present invention. FIG. 12 is a simplified block diagram of a computer system 500 for interpreting sampled mud gas compositional and isotopic data in a drilling operation of a target area. The computer system 500 includes a computer 502, a memory 504, and a user interface 506. In addition, the computer 502 includes a trend analyzer 508. The computer may be any computing device providing common computational functions. The computer is connected to the memory 504 which stores data inputted to the computer through the user interface 506. The user interface may be any device allowing input of data from a user 510 to the computer. Additionally, the user interface allows presentation of the results of the analysis of the data. The trend analyzer 508 is embedded within the computer and provides analysis of the inputted data to determine trends. The trend analyzer identifies and calculates trends and relationships based on a mathematical algorithm, function or equation. The computer receives well log data (e.g., geophysical, geological, engineering, geochemical, isotopic, and log data) through the user interface. The user interface may be a direct link from any type of digital data pipeline or any device interfacing with a user. The computer outputs the result as desired by the operator (e.g., data, logs or other graphical display

The present invention incorporates the novel interpretive methodologies disclosed in U.S. Pat. No. 7,124,030, U.S. Pat. No. 7,174,254 and U.S. patent application Ser. No. 11/671,043 without utilizing plots or logs to determine the trends utilized in interpreting the data. Thus, the acquired data does not require plotting or logging on a table to interpret the data. Data is first obtained from gas samplings (analysis or measurement) of mudgases taken at discrete depth intervals. In alternate embodiments of the present invention, the interval may be varied according to the subsurface lithologies encountered. However, in any sample logging using the mud gas isotope logging technique, samplings must be obtained at sufficiently frequent intervals to determine a background trend, which may vary as depth increases or geological environments determine. The samplings are analyzed to provide gas compositional data and isotopic data. Next, the data is inputted through the user interface 506 to the computer 502. Specific ratios may be determined or calculated from the inputted data. Since the computer is receiving the data, there is no need to tabulate the data for organization in order to facilitate the compositional and isotopic ratios required for the data interpretation. In addition, the analyzed data may be produced in any form as required by the user. The present invention may also be utilized in associated with any other selected well log data.

Rather than plot the data as disclosed in U.S. Pat. No. 7,124,030 and U.S. Pat. No. 7,174,254, the computer determined trends from the inputted data. A user provides specific templates (a mathematical, formula, equation, algorithm or other function) to determine when sequential points of data actually form a trend. The templates may be stored in the memory of the computing system. For example, specific data points may form a mixing line on a plot. However, to forego the use of plots, the data previously used to identify “mixing lines” represents points of data which fall within a specific range of points. Thus, the user may input specific ranges which signify a mixing line. The trend analyzer receives information from the user to provide identification of a trend. Additionally, the trend may be identified by a mathematical equation which enables the identification of trends from the data points. The trend analyzer then determines any trends from the inputted data. Next, the computer may utilize the identified trends to determine barriers, seals and zones of good hydrocarbon communications (compartments). Mixing trends may be indicative of good hydrocarbon communication zones (e.g., compartments, charge zones, missed-pay, biodegraded zones, etc.). The start and end of identified trends may reveal breaks which equate to seals or barriers. A barrier occurs where a simple break between identified trends occurs. A seal occurs where the break is significant and the next depth data point or trend deviates substantially. The next trend either reverses direction or the next data point is far removed from the previous point or trend. Thus, the computer calculates and identifies trends representative of hydrocarbon compartments and communication. In addition, zones, seals barriers, baffles, etc. may be identified.

Areas indicative of gas/oil charge may then be identified from the determined trends and barriers, seals and zones of good hydrocarbon communications. These noteworthy areas are determined by background contrasting isotopic values associated with good hydrocarbon communication zones. Thus, significant geological characteristics are applied to geochemical analysis to provide accurate analysis during drilling operations.

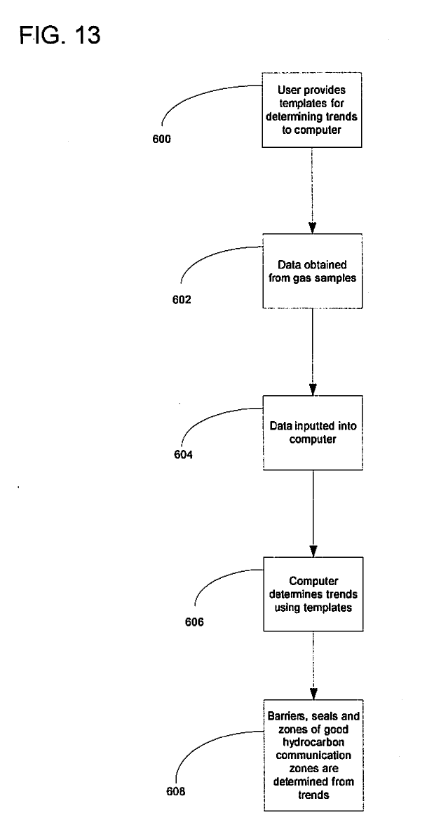

FIG. 13 is a flow chart outlining the steps for interpreting engineering and geological interpretations from data determined from mud gas isotope logging according to the teachings of the present invention. With reference to FIGS. 1-13, the steps of the method will now be explained. The method begins with step 600, where a user provides templates for determining trends. The templates may include ranges of values of various ratios and measurements which would constitute a trend. Additionally, the user may provide mathematical equations for determining when data points constitute a trend. Next, in step 602, data is obtained. Data is obtained from gas samplings of mud taken at discrete depth intervals. In alternate embodiments of the present invention, the interval may be varied according to the subsurface lithologies encountered or the analytical equipment involved. However, in any sample logging using the mud gas isotope logging technique, samplings must be obtained at sufficiently frequent intervals to determine a background trend, which may vary as depth increases or geological environments determine. The samplings are analyzed to provide gas compositional data and carbon isotopic data. Next, in step 604, the data is inputted into the computer 502 through the user interface 506. Specific ratios or other trend identification processes may be determined or calculated from the inputted data. Since the computer is receiving the data, there is no need to tabulate the data for organization in order to facilitate the compositional and isotopic ratios required for the data interpretation. In addition, computer mudgas templates (e.g., algorithms, functions, etc.) may be manipulated through the use of “optimization” parameters, such as fewer lines, cluster groups and minimum points, to better correlate with associated geophysical well logs.

Next, in step 606, the computer determines trends from the inputted data. The user provides specific ranges or optimization parameters to determine when sequential points of data actually form a trend as defined in the templates in step 600. The trend analyzer then determines when a trend occurs. Next, in step 608, the computer may utilize the identified trends to determine barriers, seals and zones of good hydrocarbon communications (compartments). Trends may be indicative of good hydrocarbon communication zones (e.g., compartments, charge zones, pissed-pay, biodegraded zones, etc.). The start and end of identified trends may reveal breaks which equate to seals, baffles, barriers, or other hydrocarbon communication zones. A barrier occurs where a simple break between identified trends occurs. A seal occurs where the break is significant and the next depth data point or trend deviates substantially. The next trend either reverses direction or the next data point is far removed from the previous point or trend. The computer outputs the data as desired by the user (e.g., data, log or other displayed result).

Areas indicative of gas/oil charge may then be identified from the determined trends and barriers, seals and zones of good hydrocarbon communications. In addition, the present invention may be utilized in association with other well logs as desired. These noteworthy areas are determined by background contrasting isotopic values associated with good hydrocarbon communication zones. Thus, significant geological characteristics are applied to geochemical analysis to provide accurate analysis during drilling operations.

The present invention determines trends without requiring the plotting of data on plots or upon logging tables. The present invention enables a user to interpret data automatically by use of the computing system 500. The determined trends may be used to interpret compartments and seals to define reservoirs containing hydrocarbons and seals that define migration pathways in the subsurface. Additionally, new interpretations may be added, such as a determination of percent thermogenic and percent microbial content to assist in characterizing hydrocarbons in the subsurface.

The present invention provides many advantages to existing interpretative methods and systems used in the oil and gas industry. The present invention determines trends from inputted data automatically and provides various interpretations of current well data points while providing additional information for effectively and accurately predicting or suggesting good hydrocarbon communication (compartments), barriers, and seals.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A method of interpreting sampled mud gas compositional and isotopic data in a drilling operation of a target area, the method comprising the steps of:
providing at least one template to a computing system for defining or identifying a trend from analyzed mud gas samplings;
obtaining a plurality of mud gas samplings from a target area;
inputting data from the plurality of mud gas samplings into the computing system;
analyzing the data from the plurality of mud gas samplings to obtain hydrocarbon compositional and isotopic data points associated with hydrocarbon isotopic composition of the plurality of gas samplings, the data points including information on composition of hydrocarbons within each of the mud gas samplings;
determining a trend of the data points associated with the template;
deriving from the trend an interpretation of the obtained mud gas samplings indicative of hydrocarbon communication or compartmentalization.

2. The method of interpreting sampled mud gas compositional and isotopic data of claim 1 wherein the derived interpretation of the log includes gas isotopic data.

3. The method of interpreting sampled mud gas compositional and isotopic data of claim 1 wherein the isotopic data is utilized to verify information from the mudgas and geophysical and well log information.

4. The method of interpreting sampled mud gas compositional and isotopic data of claim 1 wherein the step of analyzing the plurality of mud gas samplings includes determining a δ¹³C and ²H composition within the mud gas samplings.

5. The method of interpreting sampled mud gas compositional and isotopic data of claim 1 wherein a break in at least two determined trends indicates a hydrocarbon communication barrier, baffle or seal.

6. The method of interpreting sampled mud gas compositional and isotopic data of claim 5 wherein the break is large and is indicative of a seal.

7. The method of interpreting sampled mud gas compositional and isotopic data of claim 5 wherein the break is small and is indicative of a baffle or other barrier to hydrocarbon communication.

8. The method of interpreting sampled mud gas compositional and isotopic data of claim 1 further comprising the steps of:
incorporating the interpretation derived from a trend in a first well within a target area with a second interpretation derived from a trend in a second well; and
determining hydrocarbon communication zones or compartments from the incorporated interpretations.

9. The method of interpreting sampled mud gas compositional and isotopic data of claim 1 wherein the interpretation of the obtained mud gas samplings indicative of hydrocarbon communication or compartmentalization is indicative of missed-pay, charge recognition, biodegration or seal identification.

10. The method of interpreting sampled mud gas compositional and isotopic data of claim 1 wherein the interpretation of the obtained mud gas samplings indicative of hydrocarbon communication or compartmentalization indicates diffusion or other leakage of reservoir gases.

11. The method of interpreting sampled mud gas compositional and isotopic data of claim 1 wherein the interpretation of the obtained mud gas samplings indicative of hydrocarbon communication or compartmentalization indicates low or high gas reservoir saturations.

12. The method of interpreting sampled mud gas compositional and isotopic data of claim 1 further comprising the step of interpreting low and high gas saturations in stratigraphic zones wherein analysis of isotopic data is used to determine an effectiveness of sealing intervals associated with movement of hydrocarbons from oil and gas in the target area.

13. A method of interpreting sampled mud gas compositional and isotopic data in a drilling operation of a target area, the method comprising the steps of:
providing at least one template for defining a trend from analyzed mud gas samplings to a computing system;
profiling a plurality of analyzed mud gas samplings through a well bore at a plurality of incremental depths of the well bore;
inputting data from the plurality of mud gas samplings into the computing system;
analyzing, by the computing system, the data from the plurality of gas samplings to obtain a plurality of isotopic data points associated with hydrocarbon isotopic composition of the plurality of gas samplings, the plurality of isotopic data points includes data associated with a composition of hydrocarbons within each of the mud gas samplings;
determining geological information from the target area derived from the plotted plurality of isotopic data points;
analyzing the plurality of isotopic data points to geological interpret the geochemical information.

14. The method of interpreting sampled mud gas compositional and isotopic data of claim 13 wherein the derived interpretation includes gas isotopic data.

15. The method of interpreting sampled mud gas compositional and isotopic data of claim 13 wherein the isotope data points are utilized to verify information from the mudgas and geophysical and well log information.

16. A system for interpreting sampled mud gas compositional and isotopic data in a drilling operation of a target area, the system comprising:
means for providing at least one template for defining or identifying a trend from analyzed mud gas samplings to a computing system;
means for inputting data from a plurality of analyzed mud gas samplings in the computing system, the plurality of analyzed mud gas samplings obtained from a target area;
means for analyzing data from the plurality of mud gas samplings to obtain hydrocarbon compositional and isotopic data points associated with the plurality of gas samplings, the data points including information on composition of hydrocarbons within each of the mud gas samplings;
means for determining a trend of the data points associated with the template;
wherein an interpretation of the obtained mud gas samplings is indicative of hydrocarbon communication or compartmentalization.

17. The system for interpreting sampled mud gas compositional and isotopic data of claim 16 wherein the means for inputting a plurality of mud gas samplings in the computing system is a user interface.

18. The system for interpreting sampled mud gas compositional and isotopic data of claim 16 wherein the means for determining a trend of the data points is a trend analyzer.

19. The system for interpreting sampled mud gas compositional and isotopic data of claim 16 wherein the interpretation derived from a trend in a first well within a target area is incorporated with a second interpretation derived from a trend in a second well and hydrocarbon communication zones or compartments in a field are determined from the incorporated interpretations.

20. The system for interpreting sampled mud gas compositional and isotopic data of claim 16 wherein the interpretation of the obtained mud gas samplings indicative of hydrocarbon communication or compartmentalization is missed-pay, charge recognition, biodegration or seal identification

21. The system for interpreting sampled mud gas compositional and isotopic data of claim 16 wherein the interpretation of the obtained mud gas samplings indicative of hydrocarbon communication or compartmentalization indicates diffusion or other leakage of reservoir gases.

22. The system for interpreting sampled mud gas compositional and isotopic data of claim 16 wherein the interpretation of the obtained mud gas samplings indicative of hydrocarbon communication or compartmentalization indicates low or high gas reservoir saturations.

23. The system for interpreting sampled mud gas compositional and isotopic data of claim 16 further comprising:
means for identifying intact seals and seals that leak hydrocarbons from a charge in background isotopic signatures and identified isotopic trends;
means for calibration between physical property measurements of shale or other caprocks and the ability to seal; and
means for identifying oil and gas charge of the same type and maturity located in reservoir sands between identified local and regional seals.

24. The system for interpreting sampled mud gas compositional and isotopic data of claim 16 further comprising means for evaluating and predicting reservoir seals to verify a presence of any sealing lithology regardless of origin.

25. The system for interpreting sampled mud gas compositional and isotopic data of claim 16 further comprising:
means for interpreting isotopic measurements made on mudgas samplings from either side of a potentially sealing interval, said interpreting means having:
means for determine the effectiveness of a seal; and
means for establish likely migration pathways and reservoir compartmentalization;
means for measuring changes in background isotopic signals of intact seals versus seals that leak hydrocarbons; and
means for calibrating between physical property measurements of seals and the ability to seal by preventing or impeding movement of oil and gas hydrocarbons.
